(19) United States
(12) Patent Application Publication
(10) Pub. No.: US 2007/0262697 A1
(43) Pub. Date: Nov. 15, 2007

(54) ELECTRON EMISSION DEVICE AND LIGHT EMISSION DEVICE INCLUDING THE ELECTRON EMISSION DEVICE

(76) Inventor: Ki-Hyun Noh, Yongin-si (KR)

Correspondence Address: CHRISTIE, PARKER & HALE, LLP, PO BOX 7068, PASADENA, CA, 91109-7068, US

(21) Appl. No.: 11/686,929

(22) Filed: Mar. 15, 2007

(30) Foreign Application Priority Data
Mar. 20, 2006 (KR) 10-2006-0025237

(51) Int. Cl. H01J 63/04; H01J 1/46

(52) U.S. Cl. 313/496; 313/293

(57) ABSTRACT

An electron emission device and a light emission device using the electron emission device are provided. The electron emission device includes cathode electrodes, gate electrodes that are located above the cathode electrodes, and electron emission regions that are electrically connected to the cathode electrodes. Each of the cathode electrodes includes a main electrode having openings and adapted to receive a driving voltage, a plurality of isolation electrodes on which the electron emission regions are located, the isolation electrodes being located in the openings of the main electrode, and a resistive layer that connects the main electrode to the isolation electrodes. Each of the isolation electrodes includes a first region contacting the resistive layer and a second region on which at least one of the electron emission regions is located. A width of the second region is greater than a width of the first region.

### CROSS-REFERENCE TO RELATED APPLICATION

This application claims priority to and the benefit of Korean Patent Application No. 10-2006-0025237, filed on Mar. 20, 2006 in the Korean Intellectual Property Office, the entire content of which is incorporated herein by reference.

### BACKGROUND OF THE INVENTION

1. Field of the Invention

The present invention relates to a light emission device and, more particularly, to an electron emission device having a resistive layer for uniformly controlling an electron emission property of electron emission regions, and a light emission device using the electron emission device.

2. Description of the Related Art

A field emission array (FEA) type electron emission device includes cathode electrodes, gate electrodes crossing the cathode electrodes, an insulating layer interposed between the cathode electrodes and the gate electrodes, and electron emission regions provided on the cathode electrodes at each intersection regions of the cathode and gate electrodes. Openings are formed in the gate electrodes and the insulating layer, and the electron emission regions are formed on the cathode electrodes in the respective openings of the insulating layer.

When predetermined driving voltages are applied to the cathode and gate electrodes, an electric field is formed around the electron emission regions by a voltage difference between the cathode and gate electrodes to emit electrons from the electron emission regions.

A light emission device includes the electron emission device, and a phosphor layer and an anode electrode that face the electron emission device within a vacuum vessel. The light emission device is designed to emit visible light by exciting the phosphor layer using the electrons emitted from the electron emission regions. At this point, the anode electrode is applied with a positive direct current (DC) voltage (an anode voltage) of hundreds through thousands of volts to accelerate the electrons emitted from the electron emission regions toward the phosphor layer.

### SUMMARY OF THE INVENTION

Exemplary embodiments according to the present invention provide an electron emission device that can realize a high resolution by improving a shape preciseness of openings of an insulating layer and prevent a current from leaking between the cathode electrodes and the gate electrodes by enhancing a voltage resistance property of the insulating layer. Exemplary embodiments according to the present invention also provide a light emission device using the electron emission device.

In an exemplary embodiment of the present invention, an electron emission device includes a substrate, cathode electrodes disposed on the substrate, gate electrodes located above the cathode electrodes, the gate electrodes crossing the cathode electrodes; an insulating layer interposed between the cathode electrodes and the gate electrodes, and electron emission regions electrically connected to the cathode electrodes. Each of the cathode electrodes includes a main electrode having openings and adapted to receive a driving voltage, a plurality of isolation electrodes on which the electron emission regions are located, the isolation electrodes being located in the openings of the main electrode and spaced apart from the main electrode, and a resistive layer connecting the main electrode to the isolation electrodes, wherein each of the isolation electrodes includes a first region contacting the resistive layer and a second region on which at least one of the electron emission regions is located, and wherein a width of the second region is greater than a width of the first region.

The gate electrodes and the insulating layer may have respective openings defined over the second region, and the width of the second region may be greater than respective diameters of the openings of the gate electrodes and the insulating layer. The isolation electrodes may be arranged in parallel and spaced apart from each other in a length direction of the main electrode. A pair of the openings of the main electrode may be arranged in a width direction of the main electrode and a pair of the isolation electrodes may be arranged in the width direction.

The resistive layer may at least partly cover top surfaces of the main electrode and the first region of the isolation electrodes. The electron emission device may further include a focusing electrode disposed above the gate electrodes and insulated from the gate electrodes.

In another exemplary embodiment of the present invention, a light emission device includes first and second substrates facing each other, cathode electrodes disposed on a surface of the first substrate facing the second substrate, gate electrodes located above the cathode electrodes, the gate electrodes crossing the cathode electrodes, an insulating layer interposed between the cathode electrodes and the gate electrodes, and electron emission regions electrically connected to the cathode electrodes, a phosphor layer located on a surface of the second substrate facing the first substrate, and an anode electrode disposed at one side of the phosphor layer. Each of the cathode electrodes includes a main electrode having openings adapted to receive a driving voltage, a plurality of isolation electrodes on which the electron emission regions are located, the isolation electrodes being located in the openings of the main electrode and spaced apart from the main electrode, and a resistive layer connecting the main electrode to the isolation electrodes, wherein each of the isolation electrodes includes a first region contacting the resistive layer and a second region on which at least one of the electron emission regions is located, and wherein a width of the second region is greater than a width of the first region.

The phosphor layer may be adapted to emit white light. Alternatively, the phosphor layer may include red, green, blue phosphor layers. In the latter case, a black layer may be located between the phosphor layers.

### BRIEF DESCRIPTION OF THE DRAWINGS

FIG. 1 is a partial sectional view of a light emission device according to a first exemplary embodiment of the present invention.

FIG. 2 is a partial enlarged view of a main electrode and isolation electrodes of a cathode electrode of the light emission device of FIG. 1.

FIG. 3 is a partial enlarged view of a cathode electrode of the light emission device of FIG. 1.

FIG. 4 is a partial cut-away view of an electron emission device of the light emission device of FIG. 1.

FIG. 5 is a partial enlarged top plane view of a cathode electrode and electron emission regions of the light emission device of FIG. 1.

FIG. 6 is a partial sectional view of a light emission device according to a second exemplary embodiment of the present invention.

### DETAILED DESCRIPTION

The present invention will now be described more fully with reference to the accompanying drawings, in which exemplary embodiments of the invention are shown. The invention may, however, be embodied in many different forms and should not be construed as being limited to the embodiments set forth herein; rather these embodiments are provided so that this disclosure will be thorough and complete, and will fully convey the concept of the invention to those skilled in the art.

In the light emission device, an electron emission property may not become uniform due to, for example, an unstable driving voltage or a voltage drop of the cathode electrodes. As a result, the light emission uniformity at each location may be deteriorated. Therefore, in order to improve the uniformity of the emission properties of the electron emission regions, a structure where the cathode electrode includes a main electrode, isolation electrodes on which the electron emission regions are located, and a resistive layer electrically connecting the main electrode to the isolation electrodes has been proposed.

However, due to the thickness of the isolation electrodes, a surface of the insulating layer is formed to be uneven between top surfaces of the isolation electrodes and portions defined between the isolation electrodes. Therefore, when the openings of the insulating layer are formed through a wet-etching process, the etching solution may permeate into undesired portions, i.e., portions defined between the isolation electrodes due to the uneven surface of the insulating layer.

As a result, the openings of the insulating layer may be formed with an undesired size. That is, the openings of the insulating layer may extend toward an external side of the isolation electrodes, and thus the shape preciseness of the openings of the insulating layer may be deteriorated. In addition, a withstanding voltage property of the insulating layer may be deteriorated, and thus a current may leak between the cathode electrodes and the gate electrodes.

In exemplary embodiments of the present invention, a light emission device encompasses all devices that can emit light to the exterior of the device. By way of example, the light emission device as disclosed herein may be used in any and all suitable displays that can transmit information by displaying symbols, letters, numbers, and/or images. Further, the light emission device may be used as a light source (e.g., backlight) for emitting light to a passive type display panel (e.g., liquid crystal panel).

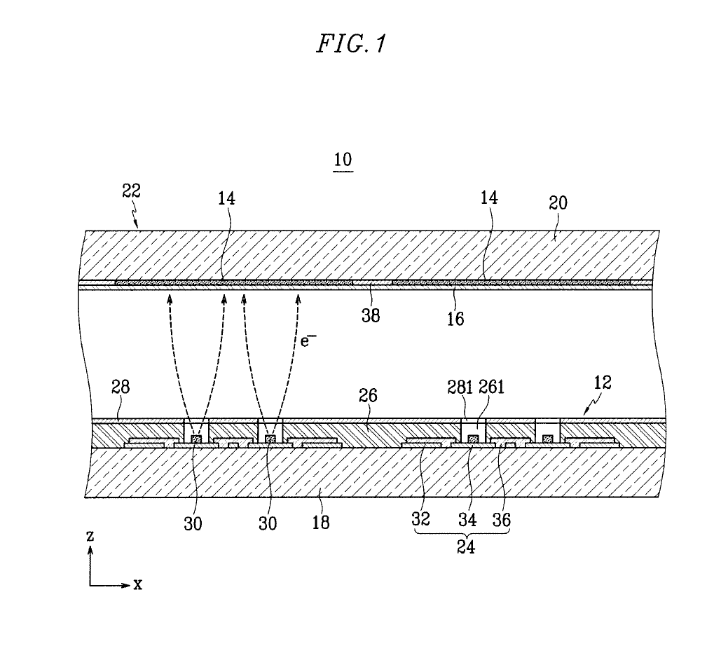

Referring to FIG. 1, a light emission device 10 of a first exemplary embodiment of the present embodiment includes an electron emission device 12, and a phosphor layer 14 and an anode electrode 16 that face the electron emission device 12. The electron emission device 12 and the phosphor layer 14 and anode electrode 16 are enclosed in a vacuum envelope. The electron emission device 12 includes a first substrate 18. The phosphor layer 14 and the anode electrode 16 are located on a second substrate 20. A sealing member (not shown) is provided between the first and second substrates 18 and 20 to seal them together and thus form a vacuum vessel 22. In one embodiment, the interior of the vacuum vessel 22 is exhausted to be kept to a degree of vacuum of about 10⁻⁶ Torr.

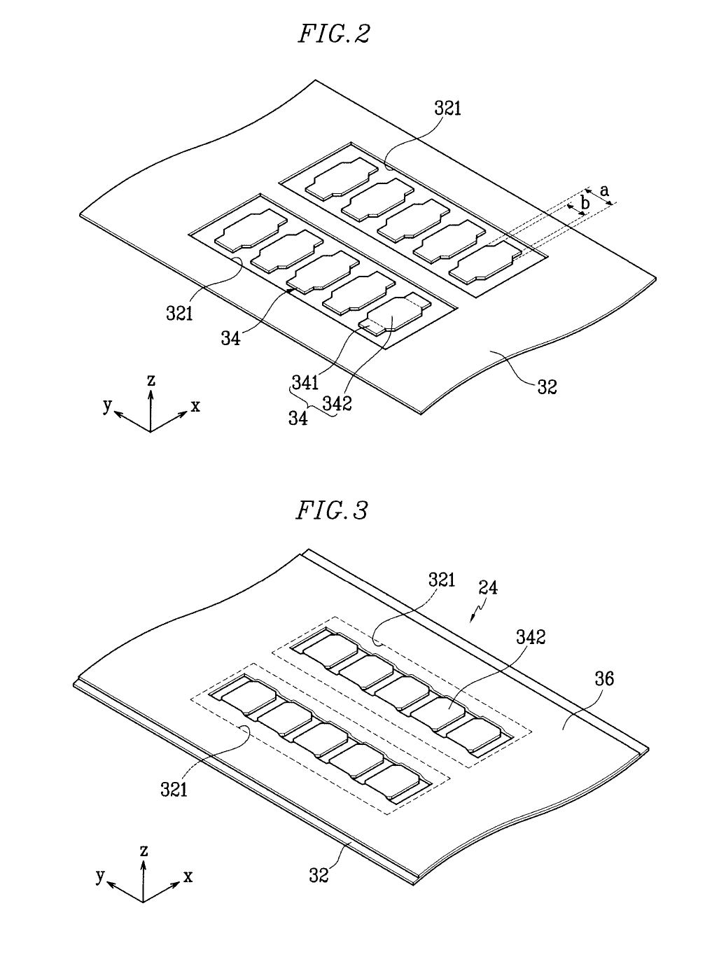

Cathode electrodes 24 are formed on the first substrate 18. The cathode electrodes 24 are arranged in a stripe pattern extending in a first direction (e.g., y-direction in FIG. 2) on the first substrate 18. An insulating layer 26 is formed on substantially an entire surface of the first substrate 18 while covering the cathode electrodes 24. Gate electrodes 28 are formed on the insulating layer 26 and arranged in a stripe pattern extending in a direction (e.g., x-direction in FIGS. 1-3) crossing the first direction at a right angle. In one embodiment, each crossing region of the cathode and gate electrode 24 and 28 may correspond to one pixel region of the light emission device 10.

Openings 281 and openings 261, which correspond to the respective pixel regions, are respectively formed in the gate electrodes 28 and the insulating layer 26 to partly expose the surface of the cathode electrodes 24. Electron emission regions 30 are located on the cathode electrodes 24 in the openings 261 of the insulating layer 26.

The electron emission regions 30 are formed of a material that emits electrons when an electric field is applied thereto under a vacuum atmosphere (or vacuum condition), such as a carbon-based material or a nanometer-sized material. For example, the electron emission regions 30 can be formed of carbon nanotubes, graphite, graphite nanofibers, diamonds, diamond-like carbon, fullerene C₆₀, silicon nanowires or any combination thereof. The electron emission regions 30 may be formed through a screen-printing process, a direct growth process, a chemical vapor deposition, or a sputtering process.

Alternatively, the electron emission regions may be formed in a tip structure formed of a Mo-based or Si-based material.

In the present exemplary embodiment, the cathode electrode 24 includes a main electrode 32 applied with a driving voltage and provided with openings for the respective pixel regions, a plurality of isolation electrodes 34 spaced apart from the main electrode 32 in the openings, and a resistive layer 36 for connecting the isolation electrodes 34 to the main electrode 32 at both sides of the isolation electrodes 34.

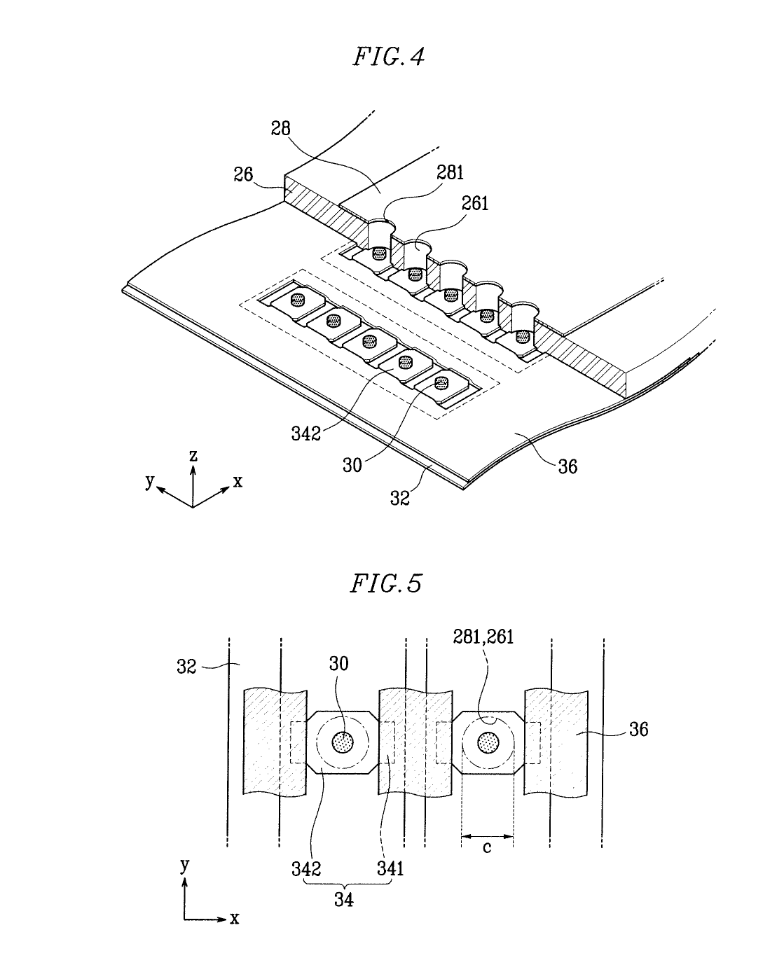

Referring to FIGS. 2 through 5, a pair of openings 321 are formed in the main electrode 32 at each pixel region. The pair of openings 321 may be arranged in parallel and spaced apart from each other in a width direction (e.g., the x-axis direction) of the main electrode 32. The isolation electrodes 34 may be arranged in parallel and spaced apart from each other in a length direction (e.g., the y-axis direction) of the main electrode 32. In one embodiment, the number of the electron emission regions 30 that are located at each pixel region can be increased.

The resistive layer 36 may contact side surfaces of the main and isolation electrodes 32 and 34. Alternatively, the resistive layer 36 may be formed to partly cover top surfaces of the main and isolation electrodes 32 and 34 to reduce a contact resistance with the main and isolation electrodes 32 and 34. The resistive layer 36 may be formed of amorphous silicon doped with p or n-type ions. In one embodiment, the resistive layer 36 may have a resistivity ranging from 10,000 Ωcm to 100,000 Ωcm.

Each of the isolation electrodes 34 includes a first region 341 contacting the resistive layer 36 and a second region 342 on which the electron emission region 30 is located. A width (“a” of FIG. 2) of the second region 342 is greater than a width (“b” of FIG. 2) of the first region. That is, each of the isolation electrodes 34 has the greatest width at a central portion on which the electron emission region 30 is located. Here, the first region 341 may be fully covered with the resistive layer 36.

The width “a” of the second region 342 is greater than a diameter (“c” of FIG. 5) of each of the openings 281 of the gate electrodes 28 and the openings 261 of the insulating layer 26.

As the second region 342 of the isolation electrode 34 is enlarged, the unevenness of the surface of the insulating layer 26 around the openings 281 of the gate electrodes 28 can be reduced or minimized when the insulating layer 26 is formed on the cathode electrodes 24. Therefore, when the openings 261 are formed in the insulating layer 26 using etching solution, the permeation of the etching solution into portions defined between the isolation electrodes 34 can be reduced or suppressed and thus the openings 261 of the insulating layer 26 can be precisely formed with a desired shape and size.

As a result, the degree of integration of the openings 261 of the insulating layer 26 and the openings 281 of the gate electrodes 28 can be increased and thus the light emission device 10 of the present exemplary embodiment can realize a high resolution. Furthermore, the withstanding voltage characteristic of the insulating layer is improved and thus the current leakage between the cathode and gate electrodes 24 and 28 can be reduced or minimized.

Referring back to FIG. 1, the phosphor layer 14 and the anode electrode 16 are located on an inner surface of the second substrate 20. The phosphor layer 14 may be a phosphor layer that can emit white light as the red, green and blue phosphors are mixed. In this case, the phosphor layer 14 may be formed on the inner surface of the second substrate 20 at an overall active region or formed having a plurality of sections corresponding to the pixel regions. The light emission device 10 having the phosphor layer 14 may be used as a light source for emitting light to a passive-type display panel (e.g., liquid crystal panel).

Alternatively, the phosphor layer 14 may be formed with red, green, and blue phosphor layers corresponding to the respective pixel regions. In this case, a black layer 38 for enhancing the contrast of the image may be formed between the red, green and blue phosphor layers 14. The light emission device 10 having the phosphor layers 14 and the black layer 38 may be used as a display device.

The anode electrode 16 that is a metal layer formed of, for example, aluminum, is formed on the phosphor layer 14. The anode electrode 16 functions to place the phosphor layer 14 in a high potential state by receiving a voltage required for accelerating the electron beams and to enhance the screen luminance by reflecting the visible light radiated from the phosphor layer 14 toward the first substrate 18 to the second substrate 20.

Alternatively, the anode electrode may be a transparent conductive layer formed of, for example, indium tin oxide (ITO). In this case, the anode electrode is located between the second substrate 20 and the phosphor layer 14. Alternatively, the anode electrode may include both the transparent conductive layer and the metal layer.

Disposed between the first and second substrates 18 and 20 are spacers (not shown) for enduring compression force applied to the vacuum vessel 22 and uniformly maintaining a gap between the first and second substrates 18 and 20.

The above-described light emission device 10 is driven when driving voltages (e.g., predetermined driving voltages) are applied to the cathode, gate, and anode electrodes 24, 28, and 16. By way of example, one of the cathode electrode 24 or the gate electrode 28 is applied with a scan driving voltage to function as a scan electrode and the other is applied with a data driving voltage to serve as a data electrode. The anode electrode 16 is applied with a voltage required for accelerating the electron beams, for example, a positive direct current (DC) voltage (an anode voltage) of hundreds through thousands of volts.

Then, electric fields are formed around the electron emission regions 30 at pixels where a voltage difference between the cathode and gate electrodes 24 and 28 is greater than or equal to a threshold value and thus the electrons are emitted from the electron emission regions 30. The emitted electrons collide with the phosphor layer 14 of the corresponding pixel by being attracted by the anode voltage applied to the anode electrode 16, thereby exciting the corresponding portion of the phosphor layer 14. A light emission intensity of the phosphor layer 14 at each pixel corresponds to an emission amount of electron beams of the corresponding pixel. During the driving process, the resistive layer 36 connecting the main electrode 32 to the isolation electrodes 34 makes the emission properties of the electron emission regions 30 substantially uniform, thereby improving the light emission uniformity of the pixels.

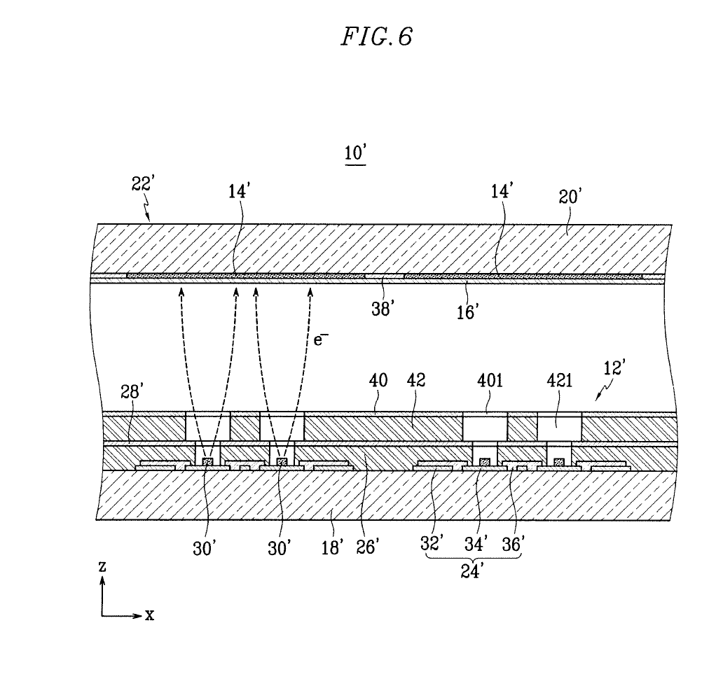

Referring to FIG. 6, a light emission device 10′ of a second exemplary embodiment of the present invention is basically identical to the light emission device 10 of the first exemplary embodiment except that it further includes a focusing electrode 40 located above gate electrodes 28′. When an insulating layer 26′ located between cathode electrodes 24′ and gate electrodes 28′ is referred to as a first insulating layer, a second insulating layer 42 is formed under the focusing electrode 40 to insulate the gate electrodes 28′ from the focusing electrode 40.

Openings 421 and openings 401 are respectively formed on the second insulating layer 42 and the focusing electrode 40. The focusing electrode 40 is applied with 0V or a negative direct current (DC) voltage of several to tens of volts. The emitted electrons are converged on a center of a bundle of electron beams while passing through the corresponding opening 401 of the focusing electrode 40.

The openings 401 of the focusing electrode 40 may be formed to correspond to the respective pixel regions. Alternatively, the openings 401 of the focusing electrode 40 may be formed to correspond to the respective electron emission regions 30′. Alternatively, the openings 401 of the focusing electrode 40 may be formed to correspond to the openings of the main electrode 32′.

Although exemplary embodiments of the present invention have been shown and described, it will be appreciated by those skilled in the art that changes may be made in this embodiment without departing from the principles and spirit of the invention, the scope of which is defined by the claims and their equivalents.

What is claimed is:

1. An electron emission device comprising:
a substrate;
cathode electrodes disposed on the substrate;
gate electrodes located above the cathode electrodes, the gate electrodes crossing the cathode electrodes;
an insulating layer interposed between the cathode electrodes and the gate electrodes; and
electron emission regions electrically connected to the cathode electrodes,
wherein each of the cathode electrodes comprises:
a main electrode having openings and adapted to receive a driving voltage;
a plurality of isolation electrodes on which the electron emission regions are located, the isolation electrodes being located in the openings of the main electrode and spaced apart from the main electrode; and
a resistive layer connecting the main electrode to the isolation electrodes, wherein each of the isolation electrodes comprises a first region contacting the resistive layer and a second region on which at least one of the electron emission regions is located, and wherein a width of the second region is greater than a width of the first region.

2. The electron emission device of claim 1, wherein the gate electrodes and the insulating layer have respective openings defined over the second region, and the width of the second region is greater than respective diameters of the openings of the gate electrodes and the insulating layer.

3. The electron emission device of claim 1, wherein the isolation electrodes are arranged in parallel and spaced apart from each other in a length direction of the main electrode.

4. The electron emission device of claim 3, wherein a pair of the openings of the main electrode are arranged in a width direction of the main electrode and a pair of the isolation electrodes are arranged in the width direction.

5. The electron emission device of claim 3, wherein the resistive layer at least partly covers top surfaces of the main electrode and the first region of the isolation electrodes.

6. The electron emission device of claim 1, further comprising a focusing electrode disposed above the gate electrodes and insulated from the gate electrodes.

7. A light emission device comprising:
a first substrate;
a second substrate spaced apart from the first substrate, the second substrate facing the first substrate;
cathode electrodes disposed on a surface of the first substrate facing the second substrate;
gate electrodes located above the cathode electrodes, the gate electrodes crossing the cathode electrodes;
an insulating layer interposed between the cathode electrodes and the gate electrodes; and
electron emission regions electrically connected to the cathode electrodes;
a phosphor layer located on a surface of the second substrate facing the first substrate; and
an anode electrode disposed at one side of the phosphor layer,
wherein each of the cathode electrodes comprises:
a main electrode having openings and adapted to receive a driving voltage;
a plurality of isolation electrodes on which the electron emission regions are located, the isolation electrodes being located in the openings of the main electrode and spaced apart from the main electrode; and
a resistive layer connecting the main electrode to the isolation electrodes,
wherein each of the isolation electrodes comprises a first region contacting the resistive layer and a second region on which at least one of the electron emission regions is located, and wherein a width of the second region is greater than a width of the first region.

8. The light emission device of claim 7, wherein the gate electrodes and the insulating layer have respective openings defined over the second region, and the width of the second region is greater than respective diameters of the openings of the gate electrodes and the insulating layer.

9. The light emission device of claim 7, wherein the isolation electrodes are arranged in parallel and spaced apart from each other in a length direction of the main electrode.

10. The light emission device of claim 9, wherein a pair of the openings of the main electrode are arranged in a width direction of the main electrode and a pair of the isolation electrodes are arranged in the width direction.

11. The light emission device of claim 9, wherein the resistive layer at least partly covers top surfaces of the main electrode and the first region of the isolation electrodes.

12. The light emission device of claim 7, further comprising a focusing electrode disposed above the gate electrodes and insulated from the gate electrodes.

13. The light emission device of claim 7, wherein the phosphor layer is adapted to emit white light.

14. The light emission device of claim 7, wherein the phosphor layer includes red, green, blue phosphor layers and a black layer is located between the phosphor layers.
